(19) United States
(12) Patent Application Publication
(10) Pub. No.: US 2008/0020605 A1
(43) Pub. Date: Jan. 24, 2008

(54) Circuit board module

(75) Inventor: Wen-Jyh Sah, Taishan Township (TW)

Correspondence Address: BIRCH STEWART KOLASCH & BIRCH, PO BOX 747, FALLS CHURCH, VA, 22040-0747, US

(73) Assignee: Gigno Technology Co., Ltd.

(21) Appl. No.: 11/878,108

(22) Filed: Jul. 20, 2007

(30) Foreign Application Priority Data
Jul. 24, 2006 (TW) 095127035
Aug. 7, 2006 (CN) 200610104248.8

(51) Int. Cl. H01R 12/00

(52) U.S. Cl. 439/74

(57) ABSTRACT

A circuit board module includes a first glass circuit board and a second glass circuit board. The first glass circuit board has a first glass substrate, and a first integrated circuit and a first electrically connecting pad, both of which are disposed on the first glass substrate and electrically connected with each other. The second glass circuit board has a second glass substrate and a second electrically connecting pad, which is disposed on the second glass substrate and electrically connected with the first electrically connecting pad of the first glass circuit board.

### CROSS REFERENCE TO RELATED APPLICATIONS

This Non-provisional application claims priority under 35 U.S.C. §119(a) on Patent Application No(s). 095127035 filed in Taiwan, Republic of China on Jul. 24, 2006, the entire contents of which are hereby incorporated by reference.

### BACKGROUND OF THE INVENTION

1. Field of Invention

The invention relates to a circuit board module, and, in particular, to a circuit board module having an integrated circuit.

2. Related Art

The rapid development of the electronic technology has caused the rising of the electronic industry. Nowadays, the information, communication or consumer electronic industry has become one of the most rapidly grown industries among the global industries. Under the development of the electronic technology, most elements are developed toward the direction of the modularization so as to satisfy the trends of the miniaturization and of saving the cost.

In the typical electronic device, the early circuit boards are mostly composed of active devices (e.g., diodes or transistors) and passive devices (e.g., resistors or capacitors), all of which are disposed on printed circuit boards. The electronic elements are electrically connected with each other through metal wires on the printed circuit board so as to achieve various required functions. However, as the functions required by the electronic device are getting more and more powerful, and the semiconductor technology, the package technology and the modularization technology are getting more and more advanced, the integrated semiconductor elements have been widely used in the miniaturized electronic products.

During the semiconductor manufacturing process, the electronic elements or electronic circuits are disposed on a silicon substrate to form the so-called integrated circuit (IC). Then, the so-called package technology is performed to cover the IC using the epoxy resin and thus to form a chip package, which may be electrically connected with a circuit board by a ball grid array (BGA). In addition, the chip-on-glass (COG) technology, the chip-on-film (COF) technology or the low-temperature poly silicon technology has been adopted in the process of manufacturing a liquid crystal display panel so as to bond a portion of an integrated driving circuit to a pixel array circuit board made of amorphous silicon thin film transistors.

In brief, the COG package technology is to dispose a die or a chip on a glass substrate through a bump; and the COF technology is to dispose a die or a chip on a flexible circuit board. Generally speaking, the COG technology is cheaper than the COF, so the COG technology is more widely used than the COF technology. However, the electronic device formed by the COG technology tends to be damaged by the thermal stresses because the heat expansion coefficient of the silicon substrate is different from that of the glass substrate in the chip package.

Therefore, it is an important subject of the invention to provide a circuit board module capable of preventing the electronic device from being influenced by the thermal stresses.

### SUMMARY OF THE INVENTION

It is therefore an object of the invention to provide a circuit board module capable of preventing an electronic device from being influenced by thermal stresses.

The invention achieves the above-identified object by providing a circuit board module including a first glass circuit board and a second glass circuit board. The first glass circuit board has a first glass substrate, and a first integrated circuit and a first electrically connecting pad, both of which are disposed on the first glass substrate and are electrically connected with each other. The second glass circuit board has a second glass substrate and a second electrically connecting pad, which is disposed on the second glass substrate and is electrically connected with the first electrically connecting pad of the first glass circuit board.

As mentioned hereinabove, the first integrated circuit is disposed on the first glass circuit board, and the second glass circuit board is electrically connected with the first glass circuit board in the circuit board module according to the invention. Consequently, since the first glass circuit board and the second glass circuit board are made of the same material, the heat expansion coefficients thereof are the same so that the circuit board module is free from being influenced by the thermal stresses.

### BRIEF DESCRIPTION OF THE DRAWINGS

The invention will become more fully understood from the detailed description given herein below illustration only, and thus is not limitative of the present invention, and wherein:

FIG. 1 is a schematic illustration showing a circuit board module according to a preferred embodiment of the invention;

FIGS. 2A to 2C are schematic illustrations showing connections between a first glass circuit board and a second glass circuit board of the circuit board module according to the preferred embodiment of the invention; and

FIG. 3 is a schematic illustration showing the circuit board module, which includes a circuit board, according to the preferred embodiment of the invention.

### DETAILED DESCRIPTION OF THE INVENTION

The present invention will be apparent from the following detailed description, which proceeds with reference to the accompanying drawings, wherein the same references relate to the same elements.

The circuit board module according to the preferred embodiment of the invention will be described with reference to the accompanying drawings.

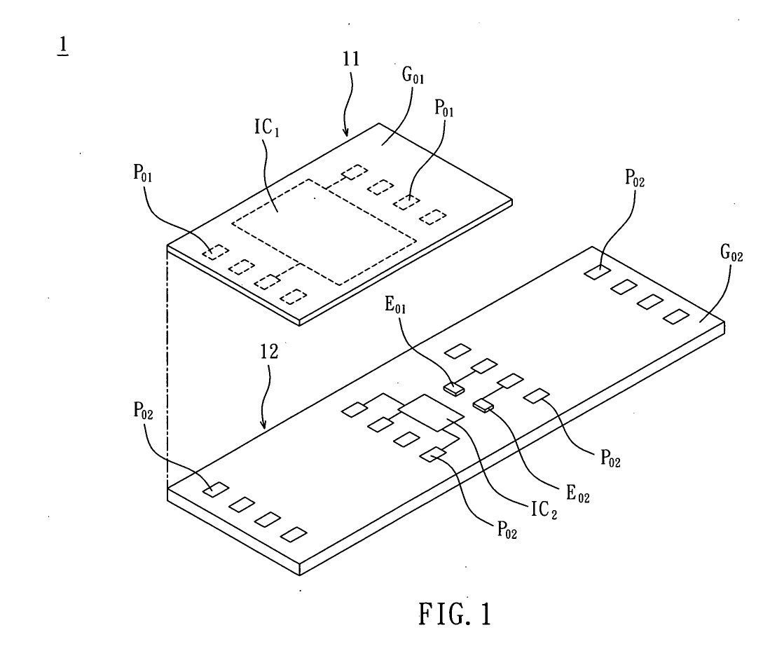

Referring to FIG. 1, a circuit board module 1 according to the preferred embodiment of the invention includes a first glass circuit board 11 and a second glass circuit board 12. In this embodiment, the circuit board module 1 may be a circuit board module of a solar energy battery or a circuit board module of a flat panel display. For example, the first glass circuit board 11 is a scan line driving circuit board of the flat panel display or a data line driving circuit board of the flat panel display, and the second glass circuit board 12 is a pixel array circuit board of the flat panel display. Of course, the circuit board module 1 of the invention may also be applied to other fields of circuit board modules, which are not particularly restricted.

The first glass circuit board 11 has a first glass substrate G₀₁, and a first electrically connecting pad P₀₁ and an integrated circuit IC₁, both of which are disposed on the first glass substrate G₀₁ and electrically connected with each other. In this embodiment, the first integrated circuit IC₁ may include an opto-electronic converting circuit, a control circuit or a driving circuit, and the first integrated circuit may be made by the low-temperature polysilicon technology or the amorphous silicon technology. That is, when the first glass circuit board 11 is to be formed, a silicon layer is first formed on the first glass substrate G₀₁ by the low-temperature polysilicon technology or the amorphous silicon technology, and then the semiconductor manufacturing processes are performed on the silicon layer.

The second glass circuit board 12 has a second glass substrate G₀₂ and a second electrically connecting pad P₀₂, which is disposed on the second glass substrate G₀₂ and electrically connected with the first electrically connecting pad of the first glass circuit board 11. In this embodiment, the second glass circuit board 12 may further include at least one active electronic element E₀₁, such as a transistor or a diode, or a passive electronic element E₀₂, such as a resistor or a capacitor. More specifically, the second glass circuit board 12 may further include a second integrated circuit IC₂, which is electrically connected with the second electrically connecting pad P₀₂. Similar to the first integrated circuit IC₁, the second integrated circuit IC₂ may also be manufactured by the polysilicon technology or the amorphous silicon technology. That is, when the second glass circuit board 12 is being manufactured, a silicon layer is first formed on the second glass substrate G₀₂ by the low-temperature polysilicon technology or the amorphous silicon technology, and then the semiconductor manufacturing processes are performed on the silicon layer.

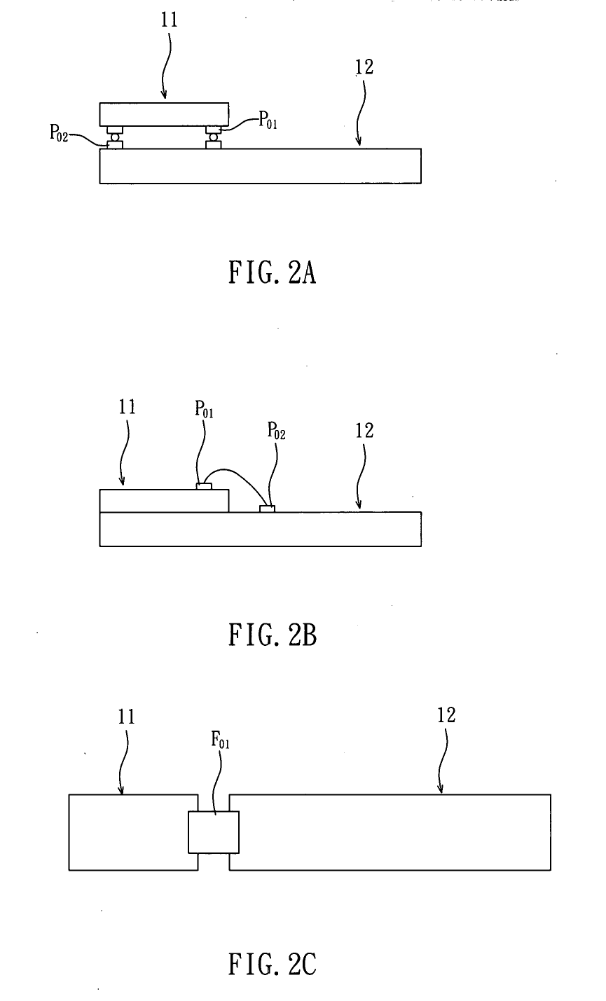

In this embodiment, the first glass circuit board 11 may be bonded to the second glass circuit board 12 by way of flip-chip bonding (see FIG. 2A), wire bonding (see FIG. 2B) or adhering (not shown). The first electrically connecting pad P₀₁ of the first glass circuit board 11 and the second electrically connecting pad P₀₂ of the second glass circuit board 12 may be electrically connected with each other through a bump, a conductive adhesive or a connecting wire. Furthermore, the first electrically connecting pad P₀₁ of the first glass circuit board 11 and the second electrically connecting pad P₀₂ of the second glass circuit board 12 may also be electrically connected with each other through a flexible cable F₀₁ (see FIG. 2C) or a flexible circuit board. In addition, a chip (not shown), such as a control unit, may also be disposed on the flexible circuit board.

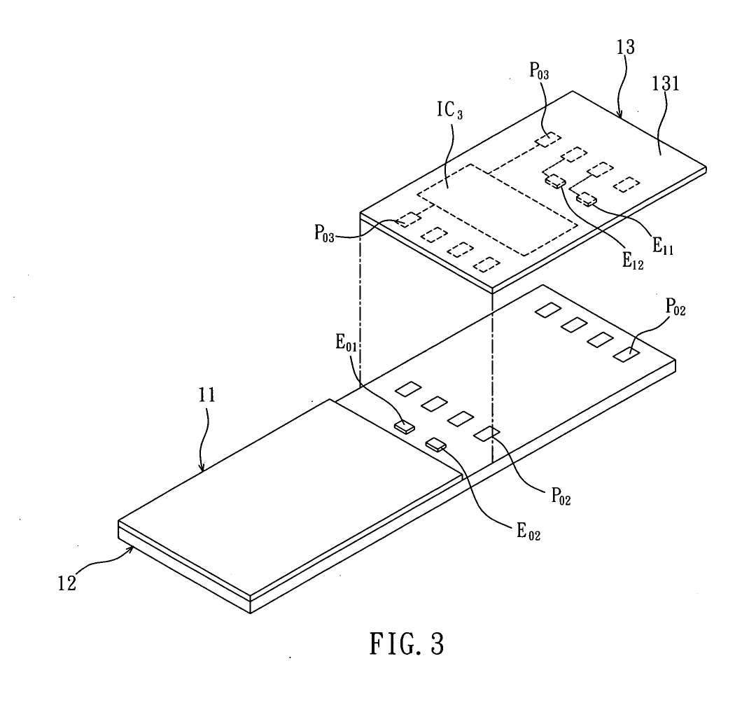

Referring to FIG. 3, the circuit board module 1 may further include a circuit board 13, which has a substrate 131 and a third electrically connecting pad P₀₃. The third electrically connecting pad P₀₃ is disposed on the substrate 131 and is electrically connected with the second electrically connecting pad P₀₂ of the second glass circuit board 12. In this embodiment, the substrate 131 may be a silicon substrate, a ceramic substrate or a glass substrate.

Similar to the second glass circuit board 12, an active electronic element E₁₁, a passive electronic element E₁₂ or a third integrated circuit IC₃ may be additionally disposed on the substrate 131 and may be electrically connected with the third electrically connecting pad P₀₃. The third integrated circuit IC₃ also includes a silicon layer formed on the substrate 131. Furthermore, similar to the bonding between the first glass circuit board 11 and the second glass circuit board 12, the circuit board 13 may be bonded to the second glass circuit board 12 by way of flip-chip bonding, wire bonding or adhering. Also, the third electrically connecting pad P₀₃ may be electrically connected with the second electrically connecting pad P₀₂ through a bump, a conductive adhesive, a connecting wire, a flexible cable or a flexible circuit board.

In this embodiment, the circuit board 13 may be electrically connected with the second glass circuit board 12 and also may be electrically connected with the first glass circuit board 11. When only the circuit board 13 is electrically connected with the first glass circuit board 11, the combination method is the same as that mentioned hereinabove, so detailed descriptions thereof will be omitted. When the circuit board 13 and the first glass circuit board 11 are simultaneously disposed on the second glass circuit board, the circuit board 13 may be electrically connected with the first glass circuit board 11 through a connecting wire (e.g., a flexible cable).

In summary, the first glass circuit board having the first integrated circuit is directly electrically connected with the second glass circuit board in the circuit board module according to the invention. Consequently, the first glass circuit board and the second glass circuit board, which are made of the same material, have the similar heat expansion coefficients, and are free from being influenced by the thermal stresses so that the circuit board module will not be influenced. In addition, the circuit board module of the invention may be applied to the electronic device such as the solar energy battery or the flat panel display, so that the used efficiency of the electronic device can also be enhanced.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A circuit board module, comprising:
a first glass circuit board having a first glass substrate, and a first integrated circuit and a first electrically connecting pad, both of which are disposed on the first glass substrate and electrically connected with each other; and
a second glass circuit board having a second glass substrate and a second electrically connecting pad, which is disposed on the second glass substrate and is electrically connected with the first electrically connecting pad.

2. The circuit board module according to claim 1, wherein the first integrated circuit comprises a silicon layer formed on the first glass substrate.

3. The circuit board module according to claim 1, wherein the first glass circuit board and the second glass circuit board are flip-chip bonded, wire bonded or adhered to each other.

4. The circuit board module according to claim 3, wherein the first electrically connecting pad of the first glass circuit board and the second electrically connecting pad of the second glass circuit board are electrically connected with each other through a bump, a conductive adhesive, a connecting wire, a flexible cable or a flexible circuit board.

5. The circuit board module according to claim 1, wherein the first integrated circuit of the first glass circuit board comprises an opto-electronic converting circuit, a control circuit or a driving circuit.

6. The circuit board module according to claim 1, wherein the second glass circuit board further comprises an active electronic element or a passive electronic element, which is electrically connected with the second electrically connecting pad.

7. The circuit board module according to claim 1, wherein the second glass circuit board further comprises a second integrated circuit electrically connected with the second electrically connecting pad.

8. The circuit board module according to claim 7, wherein the second integrated circuit comprises a silicon layer formed on the second glass substrate.

9. The circuit board module according to claim 1, further comprising a circuit board having a substrate and a third electrically connecting pad, which is disposed on the substrate and is electrically connected with the first electrically connecting pad of the first glass circuit board or the second electrically connecting pad of the second glass circuit board.

10. The circuit board module according to claim 9, wherein the substrate is a silicon substrate, a ceramic substrate or a glass substrate.

11. The circuit board module according to claim 9, wherein the circuit board further comprises an active electronic element or a passive electronic element, which is disposed on the substrate and electrically connected with the third electrically connecting pad.

12. The circuit board module according to claim 9, wherein the circuit board and the first glass circuit board are flip-chip bonded, wire bonded or adhered to each other.

13. The circuit board module according to claim 12, wherein the third electrically connecting pad of the circuit board is electrically connected with the first electrically connecting pad of the first glass circuit board through a bump, a conductive adhesive or a connecting wire.

14. The circuit board module according to claim 12, wherein the third electrically connecting pad of the circuit board is electrically connected with the first electrically connecting pad of the first glass circuit board through a flexible cable or a flexible circuit board.

15. The circuit board module according to claim 9, wherein the circuit board and the second glass circuit board are flip-chip bonded, wire bonded or adhered to each other.

16. The circuit board module according to claim 15, wherein the third electrically connecting pad of the circuit board is electrically connected with the second electrically connecting pad of the second glass circuit board through a bump, a conductive adhesive or a connecting wire.

17. The circuit board module according to claim 16, wherein the connecting wire is a flexible cable or a flexible circuit board.

18. The circuit board module according to claim 9, wherein the circuit board further comprises a third integrated circuit electrically connected with the third electrically connecting pad.

19. The circuit board module according to claim 18, wherein the third integrated circuit comprises a silicon layer formed on the substrate.

20. The circuit board module according to claim 1 being a circuit board module of a solar energy battery or a circuit board module of a flat panel display.
